(19) United States
(12) Patent Application Publication
(10) Pub. No.: US 2026/0300855 A1
(43) Pub. Date: Oct. 1, 2026

(54) Methods And Systems For Use In Scheduling Products In Growing Facilities

(71) Applicant: MONSANTO TECHNOLOGY LLC, Saint Louis, MO (US)

(72) Inventors: Ronald G. ASKIN, Phoenix, AZ (US); Dave BAITINGER, Ogden, IA (US); Michael Robert HEWITT, Glen Ellyn, IL (US); Shrikant JARUGUMILLI, O'Fallon, MO (US); Elizabeth Erin JELIC, Tucson, AZ (US); Anirudha KULKARNI, O'Fallon, MO (US); Anoop MOHAN, Wildwood, MO (US); Bijan TASLIMI, Saint Louis, MO (US); Yuqun ZHOU, Saint Louis, MO (US)

(21) Appl. No.: 19/480,343

(22) PCT Filed: Apr. 30, 2024
(86) PCT No.: PCT/US2024/026997

§ 371 Date: Oct. 30, 2025

Related U.S. Application Data
(60) Provisional application No. 63/463,270, filed on May 1, 2023.

(51) Int. Cl. G06Q 10/0631; G06Q 50/02

(52) U.S. Cl. CPC G06Q 10/06311; G06Q 50/02

(57) ABSTRACT

Example systems and methods are disclosed for determining a facility schedule for a growing facility. One example computer-implemented method includes, in response to an instruction, accessing, by a computing device, data representative of a growing facility and data representative of a product to be introduced into the growing facility and determining, by the computing device, a facility schedule based on a mixed integer programming model indicative of a product delivery schedule and resources of the growing facility. The method then includes implementing, by the computing device, the facility schedule into the growing facility.

### CROSS-REFERENCE TO RELATED APPLICATION

This application claims the benefit of, and priority to, U.S. Provisional Application No. 63/463,270, filed on May 1, 2023. The entire disclosure of the above-referenced application is incorporated herein by reference.

### FIELD

The present disclosure generally relates to methods and systems for use in scheduling inclusion and management of products (e.g., crops, etc.) in advancement growing spaces (e.g., growing facilities, etc.).

### BACKGROUND

This section provides background information related to the present disclosure which is not necessarily prior art.

In plant development, plants are modified through various mechanisms, including selective breeding, genetic modification, etc., to exhibit desirable traits. Seeds and/or plants resulting from the modifications are tested to determine the success of the modifications. In connection therewith, it is known to provide a growing facility, in which the seeds are planted, grown, managed and harvested, whereupon the testing of the seeds and/or plants may be implemented. When the modifications are successful, the plants may be promoted for further development or for commercialization.

### SUMMARY

This section provides a general summary of the disclosure, and is not a comprehensive disclosure of its full scope or all of its features.

Example embodiments of the present disclosure generally relate to computer-implemented methods for processing (e.g., allocating, etc.) products in a growing facility. One example method includes: in response to an instruction, accessing, by a computing device, data representative of a growing facility and data representative of a product to be introduced into the growing facility; determining, by the computing device, a facility schedule based on a mixed integer programming model indicative of a product delivery schedule and resources of the growing facility; and implementing, by the computing device, the facility schedule into the growing facility.

Example embodiments of the present disclosure also relate to non-transitory computer-readable storage media including executable instructions for processing (e.g., allocating, etc.) products in a growing facility. In one example embodiment, such a non-transitory computer-readable storage medium includes executable instructions, which when executed by at least one processor, cause the at least one processor to perform one or more of the above operations and/or one or more of the operations described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is an example system of the present disclosure for use in scheduling operations associated with products in a growing facility;

FIG. 2 illustrates example greenhouses of the growing facility included in the system of FIG. 1;

FIG. 3A is an example detail of a growing facility, which may be included in the system if FIG. 1;

FIG. 3B illustrates example details relating to product delivery for the growing facility of FIG. 3A;

FIG. 3C illustrates an example facility schedule that may be generated for the growing facility of FIG. 3A;

FIG. 3D illustrates example details relating to bench capacities for the growing facility of FIG. 3A;

FIG. 4 is a block diagram of an example computing device that may be used in the system of FIG. 1; and

FIG. 5 is an example method, suitable for use with the system of FIG. 1, for scheduling operations of a growing facility.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

For a specific growing facility, allocation of the resources, such as, for example, greenhouses, etc., to different products (e.g., seeds, plants, etc.), stages, etc., is important to the success of the growing facility. For example, throughput of the growing facility may indicate a number of products advancing through the growing facility (e.g., being processed therein, etc.), from seed planting to harvest. The growing facility, and in particular, workstations, capacities, movement constraints, etc. associated with the facility, however, provide(s) physical limitations on the throughput of the growing facility. At the same time, biological attributes, characteristics, etc. of the products at the growing facility may define specific time periods during which the products are planted, transplanted, pollinated, moved to different environments, etc. as part of growing and harvesting. In combination, the complex interaction of the above variables, attributes, characteristics, etc., especially for a commercial growing facility, requires evaluation, in manners that are beyond the human mind to solve, to improve throughput of the growing facility (and/or provide desired throughput for the growing facility). In contrast, conventional planning of growing facility schedules rely on human decisions (e.g., related to timing, etc.) without considering readily available information, which often leads to subjective scheduling at the growing facility (e.g., simply scheduling products in order of due dates, etc.) and which may be inconsistent with enhanced throughput of the growing facility.

Uniquely, the methods and systems herein provide for scheduling of introduction of products to and management of the products in a growing facility. In particular, for a specific growing facility, a facility schedule is determined to accommodate the arrival of products at different times and the introduction of the products into the growing facility, whereby timing of the products in the growing facility is generally consistent with the attributes, characteristics, etc. of the products, a design of the growing facility, the available resources in the growing facility, and timing of subsequent use/demand for the products (upon leaving the growing facility). In this manner, the products are disposed in proper growth stage greenhouses (broadly, growing spaces or growing zones), and accessible to workers and other resources, at times consistent with the biological demands of the products, all while improving throughput of the growing facility and limiting delay in introduction of products from sources and output of the products from the greenhouses. In connection therewith, forming the schedule, as explained herein, leverages comprehensive data related to the growing facility and the products introduced to the growing facility to yield a technical solution to scheduling, which is beyond what can be done in the human mind.

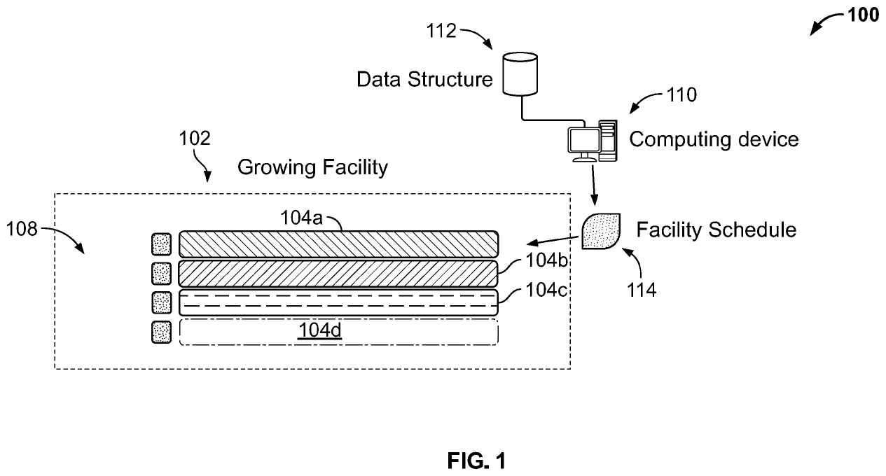

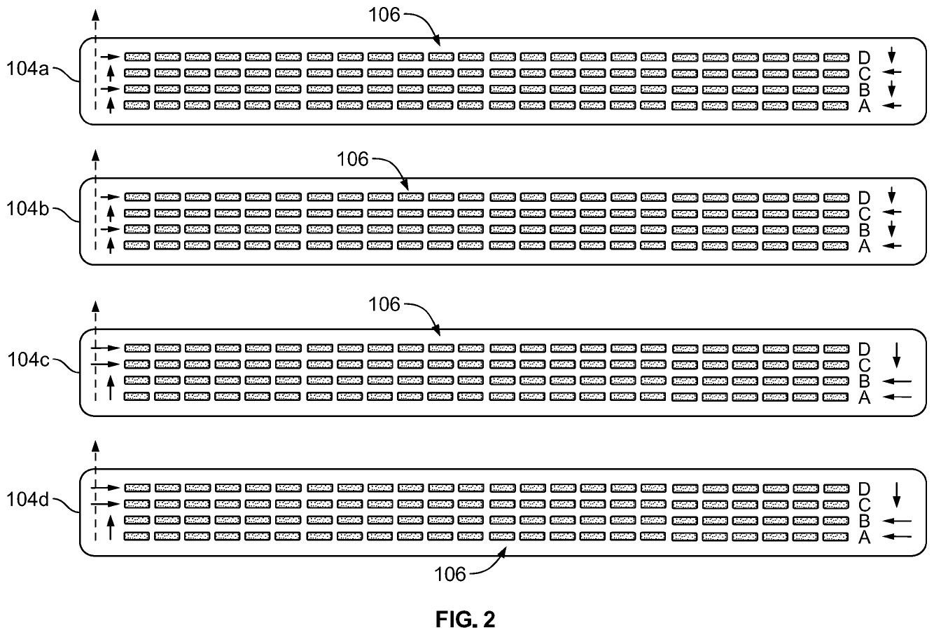

FIGS. 1-2 illustrate an example system 100 for scheduling the introduction of crop products into a growing facility (e.g., into growing spaces in the facility, etc.), and the processing of the crop products within the growing facility, and in which one or more aspects of the present disclosure may be implemented. Although, in the described embodiment, parts of the system 100 are presented in one arrangement, other embodiments may include the same or different parts arranged otherwise depending, for example, on available resources and arrangements of the resources in the growing facility, etc.

As shown in FIG. 1, the system 100 generally includes a growing facility 102, which may include a variety of different types, sizes, etc., of areas for planting, growing and harvesting crops, etc., in connection with plant advancement trials or otherwise. In this example embodiment, the growing facility 102 is an indoor space. Nonetheless, it should be appreciated that in other system embodiments, the growing facility may include outdoor space(s), or potentially, combinations of indoor space(s) and outdoor space(s).

The growing facility 102 is separated into multiple greenhouses 104a-d, or more broadly, zones. The greenhouses 104a-d, in this example embodiment, are climate-controlled spaces, in which environmental conditions within (and/or associated with) the greenhouses 104a-d are controlled to specific parameters, as desired or required. The environmental conditions may include, for example, temperature, moisture, humidity, solar radiation, wind, etc. Further, the environmental conditions in the greenhouses 104a-d may be controlled independently, such that the temperature in one greenhouse 104a is different than the temperature in another greenhouse 104b, etc. It should be appreciated that different greenhouses may be defined, either by space or by climate-control in other embodiments, whereby different conditions may be extended, or not, to the different greenhouses. In addition, it should be appreciated that one or more of the greenhouses 104a-d may be included in a same or common structure, with the particular environmental conditions for each of the one or more greenhouses 104a-d then set for the particular part of the structure associated with the greenhouses 104a-d. That said, each of the greenhouses 104a-d may be configured for a particular operation in the growing facility 202. For instance, the greenhouses 104c, 104d may include harvesting greenhouses, while other ones of the greenhouses 104a, 104b may be used for other operations described herein (e.g., leading up to the harvesting greenhouses whereby plants move through the other greenhouses and then to the harvesting greenhouses, etc.).

While only four greenhouses 104a-d are illustrated in the example of system 100, it should be appreciated that a different number of greenhouses may be included in other growing facility embodiments. For example, one or more growing facilities may include, without limitation, eight, ten, twelve, twenty or more or less green houses, etc. In addition, beyond the number of greenhouses, the arrangement of greenhouses may vary in the facility, as well as components of the greenhouses (e.g., bays, benches, conveyors, workstations, etc.).

In the system 100, each of the greenhouses 104a-d is allocated to (or is associated with) a growth stage, or potentially (in some examples) to multiple growth stages, whereby products included therein are intended to be consistent with the allocated growth stage(s). As explained in more detail below, the growth stages may include, for example, planting, germination, re-arraying, pollination, harvesting, etc., as consistent with the particular product included in the greenhouses 104a-d.

With additional reference to FIG. 2, each of the greenhouses 104a-d includes benches 106 for holding one or more products in the greenhouses 104a-d. In this example embodiment, the benches 106 are configured to support seed receptacles or plant receptacles (e.g., pots, trays, multi-well trays, etc.), in various configurations. The number of benches 106, for example, may be based on an overall capacity of the growing facility 102 and/or greenhouse 102a (or other greenhouse 102b-d), or a specific design of the growing facility 102. The benches 106 may also define any suitable size and/or configuration or surface area for holding or supporting a specific number, or a threshold number, of receptacles. For example, the benches 106 in FIG. 1 may be configured to hold a particular number (or desired number) of receptacles, for instance (and depending on the type of receptacle), about one receptacle (e.g., where the receptacle includes a tray configured to hold multiple plants (e.g., a tray configured to hold about fifty or more plants, about one-hundred or more plants, about 128 plants, etc.), about fifty or more receptacles (e.g., where the receptacle includes a pot configured to hold a plant, etc.), about one-hundred or more receptacles, etc. To this point, it should be appreciated that the number of receptacles positioned on the benches 106 may vary depending on, for example, the workflow within the growing facility 102, etc. (e.g., a double haploid (DH) workflow may include about seventy or more pots positioned on a given bench 106 (e.g., seventy-two pots, 108 pots, 128 pots, etc.) while a trait integration (TI) workflow may include less than about seventy pots positioned on a given bench (e.g., about fifty-four pots, etc.), etc.). It should also be appreciated that the benches 106 are generally consistent in size through the growing facility 102 in this embodiment, but may be different in other embodiments.

As shown in FIG. 1, the benches 106 are generally organized in a number of rows and columns (as schematically illustrated for the greenhouse 104a), and the rows and columns of benches 106 may be separated into the different greenhouses 104a-d. In the illustrated embodiment, for example, the greenhouse 104a includes four rows A-D of benches 106 divided into twenty-four columns. That said, a different number of rows and/or columns of benches, generally, may be included in other embodiments.

In this example embodiment, the growing facility 102 includes a level of automation, whereby the benches 106 are mobile, either automatically or manually, from position to position within the corresponding rows. In this particular example, the benches 106 are fixed and/or coupled to one or more conveyors, which, in turn, are configured to move the benches 106 from location to location in the growing facility 102. As shown, in this example, the four rows of benches 106 traverse the greenhouse 104a in the direction indicated by the arrows. The rows A-B traverse the greenhouse 104A from right to left, and the rows C-D traverse the greenhouse from left to right. When the benches 106 in the rows reach the end of the row, one or more conveyors are included and configured to move the benches 106 (as indicated by the arrows) from the row A to the row D, and vice-versa, and from the row B to the row C, and vice-vera. In this manner, the benches 106 in the greenhouse 104a are moved, by the conveyors included therein generally in a loop. The benches 106 in the other greenhouses 104b-d are generally arranged in the same manner, relative to conveyors, which are configured to move the benches 106 in generally the same manner.

In addition to moving the benches 106 from row A to row D, for example, the one or more conveyors are also configured to move the benches 106, at the ends of the rows as shown in FIG. 1, between the different greenhouses 104a-d, as indicated by the dotted arrow. As such, the benches 106 in greenhouse 104a, for example, may be moved, by the conveyors into greenhouse 104b (consistent with the growth stages allocated thereto), while the benches from greenhouse 104b are moved, by the conveyors, into the greenhouse 104c, and so on. In this specific embodiment, products are introduced, generally, into the greenhouse 104a and move toward greenhouse 104d over time (again, consistent with the growth stages allocated thereto).

Consequently, it should be appreciated that movement of the benches 106 in the growing facility 102 is limited by the relative movement of the benches in the individual greenhouses 104a-d of the growing facility 102. Stated another way, the benches 106 in greenhouse 104a are not movable to greenhouse 104d, unless first moved through the greenhouses 104b-c (and displacing the benches 106 disposed therein). It should be appreciated that the greenhouses may be configured otherwise in other system embodiments.

The conveyors are also associated with specific performance, such as, for example, duration, whereby movement of a bench 106 from one position (in the greenhouse 104a, for example) to another position (e.g., in the greenhouse 104a or in the greenhouse 104b, etc.) requires an amount of time (e.g., a number of minutes, etc.).

As further shown in FIG. 1, the greenhouses 104a-d also each include one or more workstations 108, which are located at the end of one or more of the rows A-D. In particular, based on the particular configuration of the benches 106, in and among the greenhouses 104a-d, in rows, access to the benches 106 is limited to the ends of the rows a-d, generally. That is, because of the relative positions of rows (and columns) of benches 106, access to a bench in the middle of row D is limited by the benches in row A, for example. As such, human interaction with the seeds/plants disposed at a particular bench is limited to the workstations 108 at one end of the row D in the greenhouse 104a, for example. While the workstation(s) 108 is/are positioned at only one end of the rows A-D in greenhouse 104a, it should be appreciated that the workstation(s) 108 may include multiple workstation disposed at either end (or both ends) of the specific rows in other embodiments, or only some of the rows in the greenhouse, but not other rows.

In addition to the workstations 108, the growing facility 102 is populated with workers (not shown), which are disposed within the growing space 102 to perform operations, such as, for example, re-arraying, pollination, treatments, harvest, etc. That said, the workers are generally positioned at the workstations 108, whereby the operations, tasks, etc. associated with the growing facility 102 generally take place at the workstations 108 (e.g., the workers may only enter other parts of the growing facility if/when the benches are not moving, etc.). A number of workers are also allocated an interval of time to complete operations. For example, a shift may include eight workers located at four workstations 108 in the greenhouses 104a-d, processing sixteen benches 106, for completing a pollination operation per first interval (e.g., where the first interval is associated with a particular timing for pollination activity (as such activity may be sensitive to a time of day) where a window of pollination may be less than five hours each day (e.g., as the temperatures rises the pollen may not remain viable for pollination, etc.), etc.), a replanting operation within a second interval, etc.

As noted above, the growing facility 102, and in particular, the greenhouses 104a-d, are allocated to (or are associated with) one or more growth stages as part of a design of the growing facility 102. In addition, as described, the benches 106 in the greenhouses 104a-d, in general, graduate from the greenhouse 104a to the greenhouse 104d, through the other greenhouses 104b-c. By designating particular greenhouses to particular growth stages, the products are required to move through the growing facility at particular timing to ensure the biological timelines of the products is consistent with the physical location of the products in the growing facility 102. In particular, for example, products from a set are planted in trays for germination in greenhouse 104a, and then, thereafter, planted in individual pots and moved (by the conveyors) into the greenhouse 104b for a next one or more growth stages, and so on through greenhouse 104c for pollination and greenhouse 104d for harvesting. Growth stages for corn (as the product), for example, may include planting, emergence, spraying for pest control, re-arraying, pollination, post pollination and harvesting, etc. It should be appreciated that a greater number of growth stages may be included for corn or maize, or the same, or different growth stages may be included for other products included in the growing facility 102, etc.

It should be further appreciated that beyond location in the growing facility 102, growth stages may define timing of specific interactions with the products. For example, a pollination growth stage may require access to particular products at a particular interval (e.g., three hours in the morning, specifically between 7 AM and 10 AM in the morning, etc.) (e.g., on successive days, etc.). Likewise, re-arraying the products (e.g., reorganizing plants/pots at a specific stage to group more similar material together in the same space (e.g., by plant size, or plant development, etc.), etc.), spraying the products, etc., may also require access to the products, for example, at the workstations 108. In connection with the different stages of the products, the products may also require, without limitations, to be exposed to certain environmental conditions (which may further impact progression of products in growth stages), or separation from certain other products (e.g., in different bays, etc.) (e.g., to prevent cross-contamination at pollination, etc.).

As such, in this example embodiment, as described, the growing facility 102 is configured to generally include a sequence of greenhouses 104a-d, each of which includes a desired growth stage (or at least one desired growth stage) (whereby the growing facility 102 includes a group of growth stages). In general, the greenhouses 104a-d of the growing facility 102 are associated with generation of seed. The seed generated at (or by) the growing facility 102, then, may be planted again to start a next cycle, for example, at the greenhouse 104a, etc. The set of greenhouses 104a-d of the growing facility 102 thus makes up a roadmap (e.g., of individual steps, or planted nurseries, within the roadmap, etc.) such as, for example, NM1 (non-marker cycle 1)-NM2 (non-marker cycle 2)-MK1 (marker cycle 1)-ZY (zygosity)-INC (increase). In general, the roadmap (and the steps included in the roadmap) will be dependent on the particular product included in the growing facility 102 (whereby the steps of the roadmap will vary depending the product). In addition, the roadmap may be decided by a grower, and the growing facility 102 then follows the roadmap for the given product and/or population of seeds associated therewith. Each greenhouse 104a-d within the roadmap has different requirements and needs in terms of space, resources and time/duration. The growth stages associated with each of the greenhouses 104a-d, then, relate to the products/plants within the given greenhouse. In some examples, groups of growth stages may be associated with a greenhouse. As noted above, the growth stages may include, for example, seed planting, germination, transplanting, growth, pollination, post pollination and harvest. And, the growth stages in turn may dictate the stage of growth of the plant in the given greenhouse(s).

In connection with the above, it should be appreciated that the products populated into the growing facility 102 may include one or multiple different types of plants.

In this example embodiment, the growing facility 102 may be populated with corn or maize (Zea mays). However, it should be appreciated that the growing facility 102 may include other plants, including, but not limited to, soybean (Glycine max), cotton (Gossypium hirsutum), peanut (Arachis hypogaea), barley (Hordeum vulgare); oats (Avena sativa); orchard grass (Dactylis glomerata); rice (Oryza sativa, including indica and japonica varieties); sorghum (Sorghum bicolor); sugar cane (Saccharum sp); tall fescue (Festuca arundinacea); turfgrass species (e.g., species: Agrostis stolonifera, Poa pratensis, Stenotaphrum secundatum, etc.); wheat (Triticum aestivum), and alfalfa (Medicago sativa), members of the genus Brassica, including broccoli, cabbage, cauliflower, canola, and rapeseed, carrot, Chinese cabbage, cucumber, dry bean, eggplant, fennel, garden beans, gourd, leek, lettuce, melon, okra, onion, pea, pepper, pumpkin, radish, spinach, squash, sweet corn, tomato, watermelon, honeydew melon, cantaloupe and other melons, banana, castorbean, coconut, coffee, cucumber, Poplar, Southern pine, Radiata pine, Douglas Fir, Eucalyptus, apple and other tree species, orange, grapefruit, lemon, lime and other citrus, clover, linseed, olive, palm, Capsicum, Piper, and Pimenta peppers, sugarbeet, sunflower, sweetgum, tea, tobacco, and other fruit, vegetable, tuber, and/or root crops. The methods and systems herein may also be used in conjunction with non-crop species, especially those used as model methods and/or systems, such as Arabidopsis, etc.

It should be appreciated that the different products may be associated with different constraints, as to the growing facility 102, timing, etc.

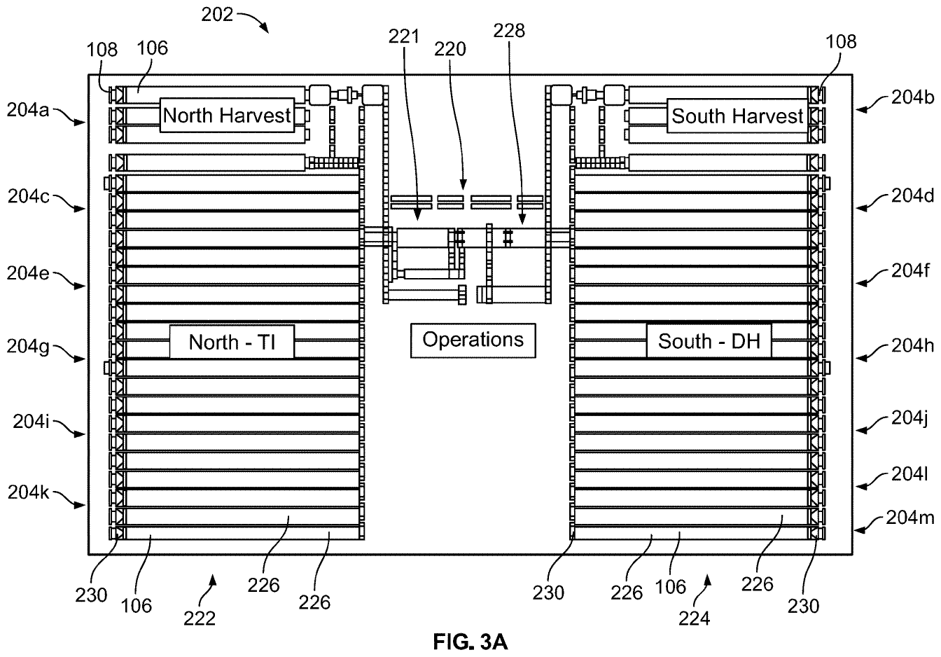

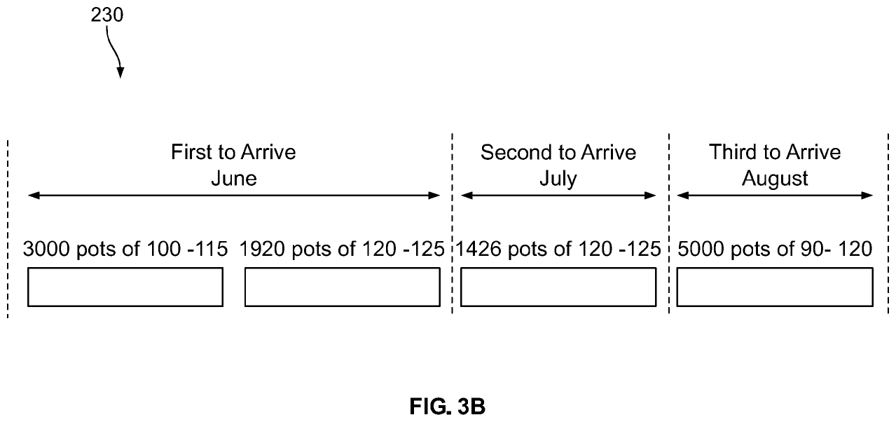

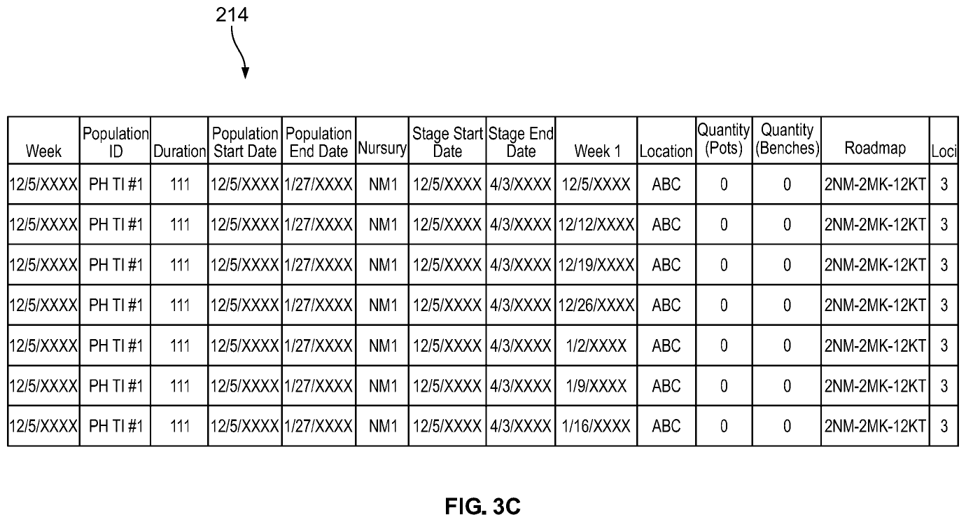

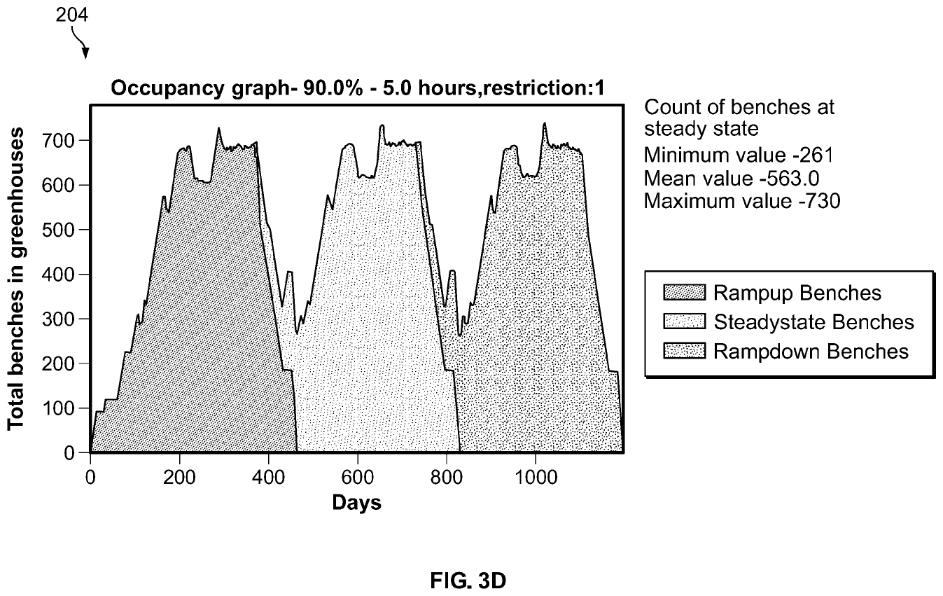

FIG. 3A illustrates another example growing facility 202 that may be used in the system 100. As shown in FIG. 3A, the example facility scheme for the growing facility 202 includes thirteen greenhouses 204a-m, disposed in two columns on either side of operations area 220 (e.g., a first side 222, or north side; and a second side 224, or south side; etc.). In particular in this example, the first side 222 of the growing facility 202 includes six greenhouses 204a, 204c, 204e, 204g, 204i, and 204k configured for a trait integration (TI) workflow. And, the second side 224 of the growing facility includes seven greenhouses 204b, 204d, 204f, 204h, 204j, 204l, and 204m configured for a double haploid (DH) workflow. Each of the greenhouses 204a-m may be configured for a particular operation in the growing facility 202. For instance, the greenhouses 204a, 204b may include harvesting greenhouses, while other ones of the greenhouses may be used for other operations described herein (e.g., leading up to the harvesting greenhouses whereby plants move through the other greenhouses and then to the harvesting greenhouses, etc.).

The operations area 220 is disposed generally between the first side 222 and the second side 224, and includes controls for controlling operations of the greenhouses 204a-204m. In connection therewith, in this example embodiment, the operations area 220 includes various automated equipment 221 including, for example, automated planting and transplanting equipment, soil mixing and distributing equipment, DH lab equipment, and germination chambers for use in performing one or more operations on the plants in the growing facility 202. As such, the operations area 220 may be used for seed planting, DH lab treatment, germination, and transplanting plants into pots. The pots, then, may be placed onto benches 106 and accumulated, for example, at a stacker yard, via conveyors 227 of a transport system 228, and then transferred to the greenhouses 204a-m (e.g., via one or more cranes of the transport system 228, etc.). In doing so, the transport system 228 generally includes multiple conveyors and robotic equipment configured to move the pots, benches, etc. as needed. In one particular example, seeds may be planted in germination trays in the operations area 220, and may then remain in germination rooms (in the operations area 220) until they are ready to be transplanted (re-planted) into pots and loaded onto benches 106 (also in operations area 220). Then, the benches 106, filled with the pots, are moved by cranes and conveyors of the transport system 228 to one or more of the greenhouses (e.g., to greenhouse 204k, 204m, etc.).

Each of the greenhouses 204a-204m includes at least one bay, where each bay includes two adjacent rows. For instance, in the illustrated embodiment, each of greenhouses 204a-204k includes two bays, and each of greenhouses 204l-204m includes one bay. In addition, each of greenhouses 204a-204b includes five rows, each of greenhouses 204c-204k includes four rows, and each of greenhouses 204l-204m includes two rows. As such, the first side 222 of the growing facility 202 includes twenty-five total rows and the second side 224 of the growing facility 202 includes twenty-five total rows.

What's more, each row in the growing facility 202 includes multiple positions extending along a length of the row (e.g., forty-three positions in the illustrated embodiment for each row in greenhouses 204a-204b, and fifty-four positions in the illustrated embodiment for each row in greenhouses 204c-204m, etc.). A bench 106, then, is located at each of the positions in each of the rows (similar to the greenhouse 104a in FIG. 1, etc.). Each of the benches 106, then, is moveable through the greenhouses 204a-204m, from position to position along the rows. For instance, in this example, the benches 106 may be fixed and/or coupled to conveyors, which, in turn, are configured to move the benches 106 from location to location (or position to position) within each of the bays, rows, etc. of the growing facility 102. As such, in greenhouse 204a, for example, the four rows of benches 106 therein traverse the greenhouse 204a, by the conveyors, generally in a loop. The benches 106 in the other greenhouses 204b-m are generally arranged in the same manner, relative to conveyors, which are configured to move the benches 106 in generally the same manner. In addition to moving the benches 106 along and between the rows in the greenhouse 204a, conveyors are also configured to move the benches 106, at the ends of the rows, from the greenhouse 204a to the greenhouse 204c, and so on.

The greenhouses 204a-m also include workstations 108, which are located at the end of rows therein. In particular, based on the particular configuration of the benches 106, in and among the greenhouses 204a-m, in rows, access to the benches 106 is limited to the ends of the rows, generally. That is, because of the relative positions of rows (and columns) of benches 106, access to a bench in the middle of a row in a greenhouse may be limited by benches 106 in adjacent rows, for example. In the illustrated embodiment, the greenhouses 204a-m each include at least one workstation 108 (e.g., one workstation 108, two workstations 108, three workstations 108, four workstations 108, etc.). In addition, in the illustrated embodiment greenhouses 204c, 204d, 204g, and 204h each include at least one specialized workstation 108 configured for use with plant growth regulator (PGR) and top flushing activities. The top flushing activities may include, for example, top flushing the soil in the benches 106, using an irrigation station, etc., as the benches 106 move through the rows of these greenhouses in order to remove accumulated minerals and sediment. And, the PGR activities may include overhead spraying activities (whereby the PGR may include an overhead sprayer, etc.) relating to one or more treatments (e.g., nutrient treatments, pesticides, etc.) configured to enhance, protect, feed, etc. the plants in the pots on the benches 106 (e.g., based on a particular time the plants have been in the growing facility 202 (e.g., around day 35 in the facility 202, etc.), about one week after re-array, etc.).

In view of the above, the example growing facility 202 may thus accommodate, for instance, upwards of about 75,000 or more individual products, from planting to harvest.

With reference again to FIG. 1, the computing device 110 is configured to account for various data and/or constraints related to the products to be introduced into the growing facility 102.

In particular, for a set of products (broadly, a population (e.g., a population of seeds, etc.)), the products may be introduced into the growing facility 102, for example, based on business priorities, expected performance, etc. Additionally, it should be understood that products may become available for release at a given time (e.g., in a given week, etc.) (e.g., from a seed provider, breeder, etc.). There is also a latest week at which the last growth stage of a product (e.g., within the last greenhouse 104d of the growing facility 102) must be completed. In connection therewith, each growth stage of a product has a length of time it requires for processing (within one or more of the greenhouses 104a-d of the growing facility 102). Products may also differ in flexibility allowed when scheduling the execution of, or introduction of, the products into a given one of the greenhouses 104a-d. Specifically, for some products, no delay is permitted between the completion of one growth stage at one greenhouse and the beginning of the next growth stage at the next greenhouse. But, for other products, delay may be permitted. In general, though, once a growth stage at a given greenhouse has begun execution, each of its subsequent growth stages is executed with no delay in between (e.g., the products are sequentially transferred to the next greenhouse associated with the next growth stage, etc.).

Given the above, in this example embodiment, the system 100 includes a computing device 110, which is configured to generate a facility schedule 114 relating to (e.g., for, etc.) the introduction of (and/or transfer of, etc.) products to the growing facility 102 (e.g., to the greenhouse 104a, etc.), and then movement of the products through the growing facility 102 (e.g., from the greenhouse 104a to the greenhouse 104b, from the greenhouse 104b to the greenhouse 104c, and so on, etc.).

Consistent therewith, the computing device 110 is configured to receive and/or retrieve certain data from a data structure 112, where the data is related to the growing facility 102 and/or the products to be introduced therein. The computing device 110 is coupled to the data structure 112, which includes data representative of the growing facility 102 (e.g., conveyor times, row data, column data, workstation data (e.g., indicating location, number, accessibility, usability, etc.), bench data, etc.). The data may be representative of various aspects of the growing facility 102, including specifically, capacities, resources (e.g., workstations 108, workers, etc.), etc.

The data structure 112 further includes data related to the specific products to be included in the growing facility 102. The data may include, for example, product growth profiles, which indicate the specific product and the timeline or timing by which the products are to progress from growth stage to growth stage (or nursery to nursery) (e.g., execution of action (e.g., pollination, etc.) during a specific time interval (e.g., week, time of day, etc.), etc.), etc. The product data may also indicate the specific greenhouses and/or growth stages to be utilized with (or for) the products, the resources required for the products in those greenhouses (e.g., workers/labor, physical space, benches, workstations, etc.), and whether the products may be subject to delay or not between the different greenhouses and/or growth stages. The product data may also include expected or target environmental conditions for the product(s), in one or more of the growth stages, etc. The product data may also indicate what products may be co-located, or not, with other products (e.g., to avoid cross-contamination, etc.). Further, the product data may include an arrival schedule for the products, which is indicative of the quantity and arrival date expected for the product. That is, the products are provided from one or more sources, including, for example, seed development programs, etc., which generally operate toward a schedule, whereby products are not automatically available upon demand but delivered to the growing facility 102 consistent with an arrival date, etc. FIG. 3B illustrates an example general timeline 230 of arrival of products to the growing facility 202, whereby the products are referenced by relative maturity (RM). As shown, the products arrive between June, July and August, with the number of products (to be included in pots) varying in counts and in RM. For example, in June 3000 pots of products are received with a RM of 100-115, and 1920 pots of products are received with a RM of 120-125. The product arrival may be expressed as a specific day or date, or more generally, month or week.

With continued reference to FIG. 1, additionally, the data structure 112 includes data representative of the crops already populated into the growing facility 102, if any, which are to also be accommodated by the facility schedule 114 for introducing further products into the growing facility 102.

It should be understood, more generally, that data explained or described herein may be available in the growing facility 102 in real time, or accessible in the data structure 112, by the computing device 110.

Based on the above data, as received or accessed, the computing device 110 is configured to generate (e.g., define, etc.) the facility schedule 114 for introducing products into the growing facility 102 (and moving the products through the growing facility 102) through a planned horizon (e.g., for determining what product to allocate to what greenhouse and when, etc.). In particular, the computing device 110 is configured to solve an objective function, as provided below, for example, whereby the objective is to schedule numerous products, up to and potentially including all products (potentially subject to priority), and to, secondarily, limit or minimize delay between availability of a product and introduction of the product into the growing facility 102. The schedule 114 includes decisions related to: whether products (e.g., a population of seeds of that product, etc.) are to be completed in a defined planning horizon, and if so, when the product should be included in the growing facility 102; the time when each greenhouse (and corresponding growth stage) should be started with the product; assignments of growth stages to specific resources (e.g., greenhouses, etc.) at specific times; and/or capacity utilization of each resource of the growing facility 102 in each period of time (e.g., in container sizes, stage sizes, etc.).

In connection therewith, there is a set of products P, which includes two groups of products: P_{d} as products for which delay may occur between nurseries (or consecutive planting cycles or steps in a roadmap (for example, which may then correspond to a particular one of the greenhouses 104a-d configured for such planting cycle(s), etc.)) and P_{nd} as products for which no delay between nurseries is permitted. These two groups of products are mutually exclusive. The products are associated with a week at which the product(s) is/are available, aₚ, and a latest week, dₚ, at which the last growth stage (at the last greenhouse of the growing facility 102) of the product must be completed. [α^{p}, β^{p}] represents a time window during which the growth stage for the product, p, must begin, where α^{p} a^{p} and where β^{p} are derived. And, wₚ represents the priority value associated with scheduling the product p, and δₚ represents the per week delay penalty for the product.

In addition, the product p requires the completion of a set of greenhouses (or nurseries) Nₚ wherein nₚ=|Nₚ|. The nursery n of product p is associated with a set of stages Sₚₙ, and the stage s∈Sₚₙ is a length of time (in weeks),

$${τ}_{s}^{pn} ,$$

it requires to process. The length of time (in weeks) is represented as

$${τ}_{n}^{p} .$$

Based on the above, β^{p} is equal to

$${d}_{p} - {\sum }_{n = 1}^{{n}_{p}} {τ}_{n}^{p} ,$$

and W=maxₚdₚ represents the last week at which any product can be completed. For products that can be delayed, the nurseries must be scheduled, in connection with the time window [α^{pn}, β^{pn}] during which nursery n of product p is to begin. As such, α^{pn} is equal to

$${α}^{p} + {\sum }_{{n}^{′} = 1}^{n - 1} {τ}_{{n}^{′}}^{p} ,$$

and regarding the end of the window, β^{pn} is equal to

$${d}_{p} - {\sum }_{{n}^{′} = n}^{{n}_{p}} {τ}_{{n}^{′}}^{p} .$$

Regarding resources, T consists of the set of resource types and Rₜ, t∈T, for the set of resources of type t. And, R=U_{t∈T}Rₜ denotes the set of all resources, while T_{c}⊆T represents the set of resource types that hold containers and wₜ as the size of the container. The resources r∈R in week w have or include or represent a capacity

$${κ}_{ w}^{r} .$$

The unity of that capacity, and whether it is in containers or stage sizes, depends on the type of resource. For stage s∈Sₚₙ of the nursery n∈Nₚ of the product p∈P, the set of resource types required is Tₛ and its size with respect to resources t∈Tₛ is

$${q}_{pns}^{t} .$$

For the products with nurseries that can be delayed,

$${e}_{pn}^{t}$$

represents the first week after nursery n begins that a resource of type t is required and

$${l}_{pn}^{t}$$

represents the last week after nursery n begins that it is required. Similarly, for products with nurseries that cannot be delayed,

$${e}_{p}^{t}$$

represents the first week after p begins that a resource of type t is required and

$${l}_{p}^{t}$$

represents the last such week.

With these data elements,

$${x}_{w}^{p} ∈ \{ 0 , 1 \}$$

indicates whether the product p is scheduled to begin in week w, and Υ^{p}∈{0,1} indicates whether the product p is scheduled in any week. Regarding nurseries of products that can be delayed, binary variable

$${y}_{w}^{pn} ∈ \{ 0 , 1 \}$$

indicates whether the nursery n of product p begins in week w. In connection therewith, binary variable

$${z}_{r}^{pns}$$

denotes whether stage s of nursery n of population p is assigned to resource r∈Rₜ, t∈Tₛ. Further, the binary variable

$${z}_{rw}^{pns}$$

denotes the same as the previous variable, albeit in week w, and

$${u}_{w}^{t}$$

denotes the total usage of resource t∈T in week w and

$${m}_{w}^{r} ,$$

r∈Rₜ, t∈T_{c} denote the number of containers of resource r of type t needed in week w.

Given these data elements and decision variables, the computing device 110 is configured to determine, or generate, the schedule 114, based on maximization of the following (objective) mixed integer model, Sched(P). In connection therewith, the first term reflects the number of jobs started, albeit weighted by their priority. The second term reflects the total delay of populations, albeit also weighted by their priority.

$${\sum }_{p ∈ P} {ω}_{p} {γ}^{P} - {\sum }_{ω = {α}^{P}}^{{β}^{p}} {δ}_{p} ( w {x}_{w}^{p} - {α}^{p} )$$

$$subject to {\sum }_{w = {α}_{p}}^{{β}_{p}} {x}_{w}^{p} = {γ}_{p} ∀ p ∈ P , \qquad ( 1 )$$

$${x}_{w}^{p} = {y}_{w}^{p 1} ∀ p ∈ {P}_{d} , w ∈ [ {α}^{p} , {β}_{p} ] , \qquad ( 2 )$$

$$w {y}_{w}^{pn} + {τ}_{n}^{p} \leq {\sum }_{{w}^{′} = {α}^{pn + 1}}^{{β}^{pn + 1}} {w}^{′} {y}_{{w}^{′}}^{pn} + {τ}_{n}^{p} * ( 1 - {x}_{w}^{p} ) \qquad ( 3 )$$

$$∀ p ∈ P , n = 1 , … , {n}_{p} - 1 , w = {α}^{pn} , … , {β}^{pn}$$

$${\sum }_{τ ∈ {R}_{i}} {z}_{r}^{pn , s} = {γ}^{p} ∀ p ∈ P , n ∈ {N}_{p} , s ∈ {S}_{pn} , t ∈ {T}_{s} , \qquad ( 4 )$$

$${z}_{rw}^{pn , s} \geq {\sum }_{{w}^{′} = w - {e}_{pn}^{i}}^{w} {y}_{w}^{pn} + {z}_{r}^{pn , s} - 1 \qquad ( 5 )$$

$$∀ p ∈ {P}_{d} , n ∈ {N}_{p} , s ∈ {S}_{pn} , r ∈ {R}_{i} , t ∈ {T}_{s} , w = 1 , … , W ,$$

$${z}_{rw}^{pn , s} \geq {\sum }_{{w}^{′} = w - {e}_{pn}^{i}}^{w} {x}_{w}^{p} + {z}_{r}^{pn , s} - 1 \qquad ( 6 )$$

$$∀ p ∈ {P}_{d} , n ∈ {N}_{p} , s ∈ {S}_{pn} , r ∈ {R}_{i} , t ∈ {T}_{s} , w = 1 , … , W ,$$

$${u}_{w}^{r} = {\sum }_{p ∈ P} {\sum }_{n ∈ {N}_{p}} {\sum }_{s ∈ {S}_{pn}} {\sum }_{t ∈ {T}_{c} : r ∈ {R}_{s}} {q}_{pn , s}^{t} {z}_{ra}^{pn , s} ∀ r ∈ R , w = 1 , … , W , \qquad ( 7 )$$

$${ω}_{t} {m}_{w}^{r} \geq {u}_{ω}^{r} ∀ t ∈ {T}_{c} , r ∈ {R}_{t} , w = 1 , … , W , \qquad ( 8 )$$

$${u}_{w}^{r} \leq {κ}_{w}^{r} ∀ r ∈ {R}_{t} , t ∈ T \backslash {T}_{c} w = 1 , … , W , \qquad ( 9 )$$

$${m}_{w}^{r} \leq {κ}_{w}^{r} ∀ r ∈ {R}_{t} , t ∈ {T}_{c} , w = 1 , … , W , \qquad ( 10 )$$

$${x}_{w}^{p} ∈ \{ 0 , 1 \} ∀ p ∈ P , w ∈ [ {α}^{p} , {β}^{p} ] , \qquad ( 11 )$$

$${γ}^{p} ∈ \{ 0 , 1 \} ∀ p ∈ P , \qquad ( 12 )$$

$${y}_{w}^{pn} ∈ \{ 0 , 1 \} ∀ p ∈ {P}_{d} , n ∈ {N}_{p} , w ∈ [ {α}^{pn} , {β}^{pn} ] , \qquad ( 13 )$$

$${z}_{t}^{pn , s} ∈ \{ 0 , 1 \} ∀ p ∈ P , n ∈ {N}_{p} , s ∈ {S}_{pn} , t ∈ {T}_{s} , \qquad ( 14 )$$

$${z}_{tw}^{pn , s} ∈ \{ 0 , 1 \} ∀ p ∈ P , n ∈ {N}_{p} , s ∈ {S}_{pn} , t ∈ {T}_{s} , w ∈ 1 , … , W , \qquad ( 15 )$$

$${u}_{w}^{r} \geq 0 , ∀ r ∈ R , w ∈ W , \qquad ( 16 )$$

$${m}_{w}^{r} ∈ ℨ ∀ r ∈ R , w ∈ W , \qquad ( 17 )$$

In maximizing the above mixed integer programming model, the computing device 110 is configured to abide by constraints (1)-(17), as described herein. Constraint (1) determines whether a given product is started. Constraint (2) ensures that for products where nurseries can be delayed, the week its first nursery begins is the same as the week the product is scheduled to begin. Constraint (3) ensure that a nursery of a product that is scheduled is not begun until the previous nursery has completed. Constraint (4) ensures that each stage of each nursery is assigned a resource of each type that the stage requires. Constraints (5) and (6) ensure that the occupancy of the resource assigned a stage aligns with when that stage is executed. Constraint (7) determines the usage of a given resource in a given week. For resources that operate on containers, constraint (8) determines the number of containers it operates on in a given week. Constraint (9) ensures that for resources that do not operate on containers, their capacity is not violated in any week. Constraint (10) is similar, albeit for resources that do operate on containers. And, constraints (11)-(17) define the decision variables and their specific domains.

In connection with the above, the left-hand side of constraint (1) sums the binary variables that reflect whether a population is started in a given week while the right-hand side of constraint (1) contains the binary variable that indicates whether the population is started. Thus, this constraint (constraint (1)) may ensure (or facilitate) that a given population is either started or not started, and if it is started, it does so in one of the eligible weeks. Constraint (2) has a binary variable indicating whether a population is started in a given week on the left-hand side and a binary variable on the right-hand side indicating whether the first stage of that population is started in that same week. Thus, this constraint may ensure (or facilitate) that for products where nurseries cannot be delayed, the week its first nursery begins is the same as the week the product is scheduled to begin.

The left-hand side of constraint (3) computes the time at which stage n of population p is completed. This is computed by first multiplying a given week during which stage n of population p can begin by the binary variable that indicates whether that stage begins in that week. Added to that product is the length of time required by stage n of population p. The right-hand side of constraint (3) computes the starting week of the next stage. Hence, constraint (3) may ensure (or facilitate) that a nursery of a product that is scheduled is not begun until the previous nursery has completed. The left-hand side of constraint (4) sums all the binary variables indicative of a resource of the type required by a given stage of a given nursery of a given population, while the right-hand side of constraint (4) contains the binary variable that indicates whether the population is started. Thus, constraint (4) may ensure (or facilitate) that each stage of each nursery is assigned a resource of each type that the stage requires.

The left-hand side of constraint (5) contains the binary variable that indicates whether a resource of a given type is assigned to a given stage of a given nursery of a given population in a given week w. The first term in the right-hand side of constraint (5) sums over all the weeks during which that stage could be started such that a resource required by that stage would be needed in week w. Since the stage can be started in exactly one week, this sum can be either 0 or 1. The second term in the right-hand side of constraint (5) is the binary variable that indicates whether the given resource is assigned to the given stage of the nursery of the population. Thus, constraint (5) may ensure (or facilitate) that the occupancy of the resource assigned a stage aligns with when that stage is executed. Constraint (5) is for populations that can be delayed. Constraint (6) is analogous, but for populations that can not be delayed. For such populations, the week during which a given resource would be occupied can be determined from the week the population began.

The left-hand side of constraint (7) contains the continuous variable that reflects the usage of a given resource in a given week. The right-hand side of constraint (7) computes the total size allocated to that resource in a given week by summing all the binary variables that represent whether a stage of a nursery of a population is assigned that resource, with each variable multiplied by the size of that stage. Constraint (8) considers resources that operate on containers. The left-hand side of constraint (8) multiplies the number of containers used by such a resource in a given week by the capacity of a container. The right-hand side of constraint (8) contains the continuous variable that represents the usage, in containers, of that resource in that week. Thus, constraint (8) may ensure (or facilitate) a sufficient number of containers are used by a resource in a given week.

Constraint (9) limits the usage of a resource that does not operate on containers by its capacity, with the left-hand side containing the usage of a resource and the right-hand side its capacity. Constraint (10) limits the number of containers a resource can operate on in a given week, with the left-hand side containing the number of containers operated on and the right-hand side its capacity in number of containers.

Constraints (11)-(17) define each class of decision variable of the model, indicating which model objects (e.g., populations, nurseries, stages, etc.) the variables are associated with. Constraints (11)-(17) also define the domains (e.g., binary, continuous, etc.) for each class of decision variable, indicating the set of acceptable values for those variables.

FIG. 3C illustrates an example facility schedule 214 that may be generated by the computing device 110, for example, for the growing facility 202. As shown, in this example, the schedule 214 includes an indication of when the plants are to be introduced to the growing facility 202, as well as an identification of the plants themselves (e.g., a population ID, etc.). The schedule 214 also includes an indication of the nursery (or greenhouse) into which the plants will be introduced and a duration therein, as well as an overall roadmap of the plants through the growing facility 202.

FIG. 3D provides an example indicator of occupancy in the greenhouses 204a-m of the growing facility 202, for example, based on application of the above mixed integer model. As shown, in this example, there is a generally high level of occupancy of benches in the greenhouses, indicating a relative high throughput and utilization (and thus, validation of the model).

With reference again to FIG. 1, once the facility schedule 114 is determined, or generated (e.g., as output of the model for determining what product to allocate to what greenhouse and when, etc.), the computing device 110 is configured to implement the facility schedule 114 (e.g., transmit instructions regarding introduction, movement, etc. of products included in the schedule 114, etc.).

Initially, for example, the computing device 110 may be configured to direct one or more products into the growing facility 102 consistent with the determined schedule. In particular, the computing device 110 is configured to interact with one or more planting mechanisms to dispose seeds delivered to the growing facility 102 into trays and to conveyors or other movement means to move the trays into position on the benches 106 of the greenhouse 104a, for example. The seeds to be introduced are located by number and made available to a planting mechanism consistent with the facility schedule. Beyond the introduction of products to the growing facility 102, the computing device 110 may be configured to advance products already in the growing facility 102 to later stages and/or to resources (e.g., workstation, workers, etc.) to accommodate the biological demands of the products (e.g., re-arraying, pollination, etc.). The additional management operations, which are defined in time and resources, in the facility schedule 114 may be accomplished by automation, in whole or in combination with the human intervention of the workers. The computing device 110 is configured to continue to implement the facility schedule 114 over time, and introduces products as prescribed and manages products as prescribed.

Additionally, or alternatively, implementation of the facility schedule 114 may include providing instructions to a human (e.g., via a printer, via display at a computing device associated with the human, etc.), implementing the instructions through control of one or more aspects of the facility, or a combination thereof. For instance, the computing device 110 may be configured to implement the facility schedule 114 through issuing instructions consistent with the schedule 114 to one or more users associated with the facility 102. This may include printing specific instructions or displaying specific instructions on a display devices associated with the user(s). In such example, the user(s) may then take part in directing one or more products into the growing facility 102 consistent with the instructions. In addition, the user(s) may also take part in planting the seeds delivered to the growing facility 102 in trays or pots consistent with the instructions and/or in planting the seeds delivered to the growing facility 102 in trays and positioning the trays on the benches 106 of the greenhouse 104a, for example, thereby conforming the facility 102 to the facility schedule 114.

It should be appreciated that the facility schedule 114 may be re-determined at one or more intervals, for example, based on updates to the delivery schedules for products to the facility 102, changes in priority of the products, changes in the growing facility 102 or products already included therein, etc. In connection therewith, the computing device 110 is configured, consistent with the above, to determine the schedule 114 in the growing facility 102.

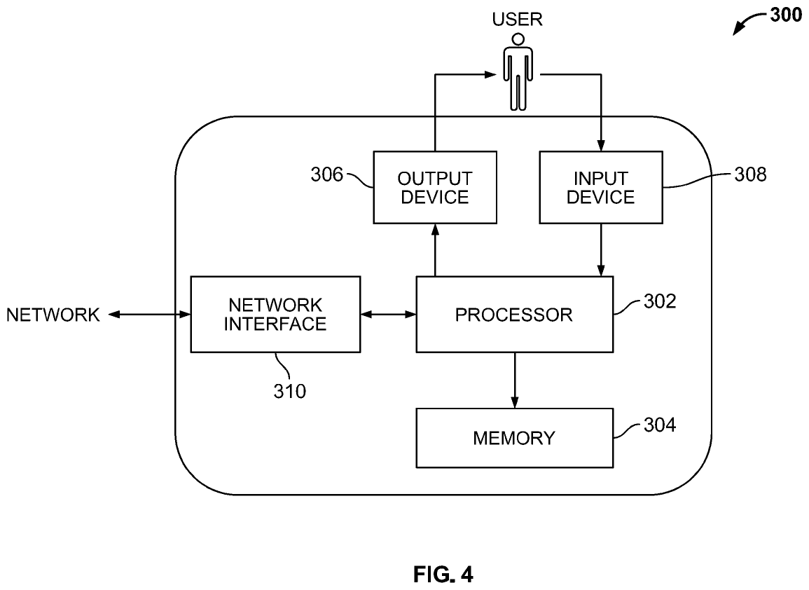

FIG. 4 illustrates an example computing device 300 that may be used in the system 100, for example, in connection with the computing device 110 and/or the data structure 112, etc., whereby each includes and/or is implemented in at least one computing device consistent with computing device 300. In connection therewith, the computing device 300 may be uniquely, or specifically, configured, by executable instructions, to implement the various algorithms and other operations described herein with regard to the computing device 110. It should be appreciated that the system 100, as described herein, may include a variety of different computing devices, either consistent with computing device 300 or different from computing device 300.

The example computing device 300 may include, for example, one or more servers, workstations, personal computers, laptops, tablets, smartphones, other suitable computing devices, combinations thereof, etc. In addition, the computing device 300 may include a single computing device, or it may include multiple computing devices located in close proximity or distributed over a geographic region, and coupled to one another via one or more networks. Such networks may include, without limitations, the Internet, an intranet, a private or public local area network (LAN), wide area network (WAN), mobile network, telecommunication networks, combinations thereof, or other suitable network(s), etc. In one example, the data structure 112 of the system 100 includes at least one server computing device, while the computing device 110 includes at least one separate computing device, which is coupled to the data structure 112, directly and/or by one or more LANs, etc.

With that said, the illustrated computing device 300 includes a processor 302 and a memory 304 that is coupled to (and in communication with) the processor 302. The processor 302 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above listing is example only, and thus is not intended to limit in any way the definition and/or meaning of processor.

The memory 304, as described herein, is one or more devices that enable information, such as executable instructions and/or other data, to be stored and retrieved. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, tapes, hard disks, and/or any other type of volatile or nonvolatile physical or tangible computer-readable media. The memory 304 may be configured to store, without limitation, product schedules, growth stage profile per product, environmental conditions, conveyor time, and/or other types of data (and/or data structures) suitable for use as described herein, etc. In various embodiments, computer-executable instructions may be stored in the memory 304 for execution by the processor 302 to cause the processor 302 to perform one or more of the functions described herein, such that the memory 304 is a physical, tangible, and non-transitory computer-readable storage media. Such instructions often improve the efficiencies and/or performance of the processor 202 that is performing one or more of the various operations herein (e.g., one or more operations of method 400, etc.) whereby such performance may transform the computing device 300 into a special-purpose computing device. It should be appreciated that the memory 304 may include a variety of different memories, each implemented in one or more of the functions or processes described herein.

In the example embodiment, the computing device 300 also includes an output device 306 that is coupled to (and is in communication with) the processor 302. The output device 306 outputs, or presents, to a user of the computing device 300 (e.g., a facility operator, etc.) by, for example, displaying and/or otherwise outputting information such as, but not limited to, the facility schedule 114, etc. It should be further appreciated that, in some embodiments, the output device 306 may comprise a display device such that various interfaces (e.g., applications (network-based or otherwise), etc.) may be displayed at computing device 300, and in particular at the display device, to display such information and data, etc. And in some examples, the computing device 300 may cause the interfaces to be displayed at a display device of another computing device, including, for example, a server hosting a website having multiple webpages, or interacting with a web application employed at the other computing device, etc. Output device 306 may include, without limitation, a liquid crystal display (LCD), a light-emitting diode (LED) display, an organic LED (OLED) display, an “electronic ink” display, combinations thereof, etc. In some embodiments, output device 306 may include multiple units.

The computing device 300 further includes an input device 308 that receives input from the user (e.g., an implementation command for a facility schedule from a facility operator, etc.). The input device 308 is coupled to (and is in communication with) the processor 302 and may include, for example, a keyboard, a pointing device, a mouse, a stylus, a touch sensitive panel (e.g., a touch pad or a touch screen, etc.), another computing device, and/or an audio input device. Further, in some example embodiments, a touch screen, such as that included in a tablet or similar device, may perform as both output device 306 and input device 308. In at least one example embodiment, the output device 306 and the input device 308 may be omitted.

In addition, the illustrated computing device 300 includes a network interface 310 coupled to (and in communication with) the processor 302 (and, in some embodiments, to the memory 304 as well). The network interface 310 may include, without limitation, a wired network adapter, a wireless network adapter, a telecommunications adapter, or other devices capable of communicating to one or more different networks. In at least one embodiment, the network interface 310 is employed to receive inputs to the computing device 300. In some example embodiments, the computing device 300 may include the processor 302 and one or more network interfaces incorporated into or with the processor 302.

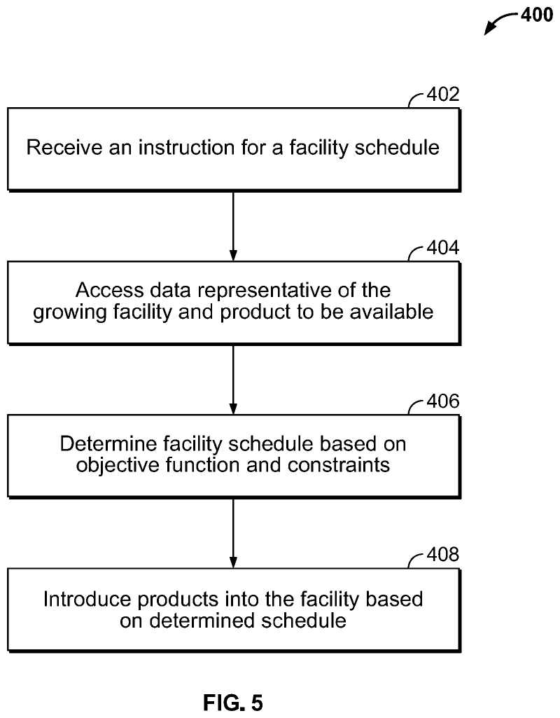

FIG. 5 illustrates an example method 400 of determining a facility schedule for a population of products into a growing facility. The example method 400 is described herein in connection with the system 100, and may be implemented, in whole or in part, in the computing device 110 of the system 100. Further, for purposes of illustration, the example method 400 is also described with reference to the computing device 110, the data structure 112, and more generally, the system 100, and also the computing device 300 of FIG. 4. However, it should be appreciated that the method 400, or other methods described herein, are not limited to the system 100 or the computing device 300. And, conversely, the systems, data structures, and computing devices described herein are not limited to the example method 400.

At the outset in method 400, it should be appreciated that relevant data related to the growing facility 102, product data, etc., is stored and accessible in the data structure 112.

Initially, then, at step 402, an instruction is received to determine a facility schedule 114 for the growing facility 102 (e.g., for determining what product to allocate to what greenhouse and when, etc.). The instruction may be received, for example, from a facility operator or another user associated with the growing facility 102, at a beginning of a growing season or cycle, or at some point after the beginning of the growing season or cycle. The instruction may include a reference to the specific growing facility 102 and/or the data representative of the growing facility 102 in the data structure 112, including, for example, products to be introduced into the growing facility 102 and a schedule of receipt of the products from a current day (or other designated day) into the future, for example, to an end of a planning horizon for the growing facility 102 and/or facility schedule 114.

It should be understood that the instruction may include or reference any suitable data to be used in determining the facility schedule 114.

At 404, the computing device 110 accesses the data relevant to the facility schedule 114 in the data structure 112 (or elsewhere as required or desired). The data, for example, may be consistent with the products to be included, the schedule of receipt of the products, the resources of the growing facility 102, and other data, as explained above or as defined or referenced in the equations and/or constraints described above.

The computing device 110 then determines, at 406, the facility schedule 114 for the growing facility 102, based on the accessed data, the mixed integer programming model, Sched(P) (e.g., the objective function herein, etc.), and the associated constraints described herein.

At 408, the computing device 110 implements the facility schedule 114.

Initially, for example, the computing device 110 implements the schedule 114 by introducing products received from a source into the growing facility 102, and in particular, into greenhouse 104a. The introduction of the products includes planting the products, which are seeds, in this example, in seed trays at one or more benches 106, via automated mechanisms alone or in combination with worker intervention, as prescribed by the facility schedule 114. By implementing the facility schedule 114, products are moved from greenhouse to greenhouse (e.g., from greenhouse 104a to greenhouse 104b, etc.) based on, for example, maximization of the mixed integer programming model described above, in view of the corresponding constraints, thereby freeing up the greenhouses for introduction of additional products (when vacated, etc.). For instance, in the growing facility 102 of FIG. 1, such application of the mixed integer model allows products to be introduced into the greenhouse 104a, once products already within the greenhouse 104a are displaced to the greenhouse 104b, based on available resources therein and consistent with the requirements of the generated schedule 114.

Likewise, products in greenhouse 104b are moved to greenhouse 104c, and so on, as products are harvested or otherwise removed from greenhouse 104d. In each greenhouse, the products are associated with specific required or desired resources, as defined by the facility schedule 114, at a time also defined by the facility schedule.

It should be appreciated that the method 400 may be repeated, as necessary, to accommodate additional data related to the products, the growing facility 102, etc. For example, where resources become unavailable due to maintenance, or product delivery schedules are altered, the method 400 may be repeated with the new/different data to determine an updated facility schedule.

In view of the above, the systems and method herein provide a facility schedule by which one or more objectives may be achieved, such as, for example, improved throughput, product completion, limited delay, etc., in an objective manner. The computing device leverages the functions and constraints described herein to accommodate a volume of data and interconnected variables for which the human mind is incapable of accommodating, especially for the hundreds or thousands of products being populated into four, five, eight, ten, twelve, fifteen or more or less greenhouses within the growing facility, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) in response to an instruction, accessing data representative of a growing facility and data representative of a product to be introduced into the growing facility; (b) determining a facility schedule based on a mixed integer model indicative of a product delivery schedule and resources of the growing facility; and/or (c) implementing the facility schedule into the growing facility.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and “at least one of” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for processing products in a growing facility, the method comprising:
in response to an instruction, accessing, by a computing device, data representative of a growing facility and data representative of a product to be introduced into the growing facility;
determining, by the computing device, a facility schedule based on a mixed integer programming model indicative of a product delivery schedule and resources of the growing facility; and
implementing, by the computing device, the facility schedule into the growing facility.

2. The method of claim 1, further comprising receiving the instruction from a facility operator of the growing facility, the instruction including an indication of the product; and
wherein the product includes one or more varieties of corn.

3. The method of claim 1, wherein determining the facility schedule includes determining the facility schedule consistent with maximizing an objective function of the mixed integer programming model, expressed as:
$${\sum }_{p ∈ P} {ω}_{p} {γ}^{P} - {\sum }_{ω = {α}^{P}}^{{β}^{p}} {δ}_{p} ( ω {x}_{w}^{p} - {α}^{p} ) .$$

4. The method of claim 1, wherein implementing the growing schedule includes:
introducing products to the growing facility at one or more greenhouses of the growing facility, consistent with the facility schedule;
advancing the products in the growing facility from the one or more greenhouses to at least another greenhouse consistent with the facility schedule; and
exposing at least one of the products in the growing facility to a resource of the growing facility consistent with the facility schedule.

5. The method of claim 1, wherein implementing the growing schedule includes:
identifying seeds for the product to be introduced into the growing facility based on the facility schedule; and
actuating, by the computing device, at least one planting mechanism to dispose the identified seeds into trays.

6. The method of claim 5, wherein the growing facility includes multiple greenhouses; and
wherein implementing the growing schedule further includes actuating, by the computing device, at least one conveyor to position at least one of the trays on a bench within a first greenhouse of the multiple greenhouses, wherein the first greenhouse is associated with a planting growth stage of the product.

7. The method of claim 6, wherein implementing the growing schedule further includes actuating, by the computing device, at least another conveyor to move the bench from the first greenhouse to a second greenhouse of the multiple greenhouses, wherein the second greenhouse is associated with a germination growth stage of the product.

8. A non-transitory computer readable storage medium including executable instructions for use in processing products in a growing facility, which, when executed by at least one processor, cause the at least one processor to:
in response to an instruction, access data representative of a growing facility and data representative of a product to be introduced into the growing facility;
determine a facility schedule based on a mixed integer programming model indicative of a product delivery schedule and resources of the growing facility; and
implement the facility schedule into the growing facility.

9. The non-transitory computer readable storage medium of claim 8, wherein the executable instructions, when executed by the at least one processor to determine the facility schedule, cause the at least one processor to determine the facility schedule consistent with maximizing an objective function of the mixed integer programming model, expressed as:
$${\sum }_{p ∈ P} {ω}_{p} {γ}^{P} - {\sum }_{ω = {α}^{P}}^{{β}^{p}} {δ}_{p} ( ω {x}_{w}^{p} - {α}^{p} ) .$$

10. The non-transitory computer readable storage medium of claim 8, wherein the executable instructions, when executed by the at least one processor to implement the growing schedule, cause the at least one processor to:
direct products to the growing facility at one or more greenhouses of the growing facility, consistent with the facility schedule;
direct advancement of the products in the growing facility from the one or more greenhouses to at least another greenhouse consistent with the facility schedule; and
expose at least one of the products in the growing facility to a resource of the growing facility consistent with the facility schedule.

11. The non-transitory computer readable storage medium of claim 8, wherein the executable instructions, when executed by the at least one processor to implement the growing schedule, cause the at least one processor to:
identify seeds for the product to be introduced into the growing facility based on the facility schedule; and
actuate at least one planting mechanism to dispose the identified seeds into trays.

12. The non-transitory computer readable storage medium of claim 11, wherein the growing facility includes multiple greenhouses; and
wherein the executable instructions, when executed by the at least one processor to implement the growing schedule, further cause the at least one processor to actuate at least one conveyor to position at least one of the trays on a bench within a first greenhouse of the multiple greenhouses, wherein the first greenhouse is associated with a planting growth stage of the product.

13. The non-transitory computer readable storage medium of claim 12, wherein the executable instructions, when executed by the at least one processor to implement the growing schedule, further cause the at least one processor to actuate at least another conveyor to move the bench from the first greenhouse to a second greenhouse of the multiple greenhouses, wherein the second greenhouse is associated with a germination growth stage of the product.

14. A system for use in processing products in a growing facility, the system comprising at least one computing device configured to:
in response to an instruction, access data representative of a growing facility and data representative of a product to be introduced into the growing facility;
determine a facility schedule based on a mixed integer programming model indicative of a product delivery schedule and resources of the growing facility; and
implement the facility schedule into the growing facility.

15. The system of claim 14, wherein the at least one computing device is configured to determine the facility schedule consistent with maximizing an objective function of the mixed integer programming model, expressed as:
$${\sum }_{p ∈ P} {ω}_{p} {γ}^{P} - {\sum }_{ω = {α}^{P}}^{{β}^{p}} {δ}_{p} ( ω {x}_{w}^{p} - {α}^{p} ) .$$

16. The system of claim 14, wherein the at least one computing device is configured, in order to implement the growing schedule, to:
direct products to the growing facility at one or more greenhouses of the growing facility, consistent with the facility schedule;
direct advancement of the products in the growing facility from the one or more greenhouses to at least another greenhouse consistent with the facility schedule; and
expose at least one of the products in the growing facility to a resource of the growing facility consistent with the facility schedule.

17. The system of claim 14, further comprising the growing facility, and wherein the growing facility includes:
multiple greenhouses each associated with at least one growth stage of the product to be introduced into the growing facility; and
at least one planting mechanism configured to plant seeds associated with the product into trays.

18. The system of claim 17, wherein the at least one computing device is configured, in order to implement the growing schedule, to:
identify the seeds associated with the product based on the facility schedule; and
actuate the at least one planting mechanism to dispose the identified seeds into the trays.

19. The system of claim 18, wherein the growing facility further includes at least one first conveyor configured to move the trays into a first greenhouse of the multiple greenhouses; and
wherein the at least one computing device is further configured, in order to implement the growing schedule, to actuate the at least one conveyor to position at least one of the trays within the first greenhouse, wherein the first greenhouse is associated with a planting growth stage of the product.

20. The system of claim 19, wherein the growing facility further includes at least one second conveyor configured to move the trays through the first greenhouse and to a second greenhouse of the multiple greenhouses; and
wherein the at least one computing device is further configured, in order to implement the growing schedule, to actuate the at least one second conveyor to move the at least one of the trays from the first greenhouse to the second greenhouse, wherein the second greenhouse is associated with a germination growth stage of the product.
